(19) United States
(12) Patent Application Publication
(10) Pub. No.: US 2026/0355935 A1
(43) Pub. Date: Nov. 12, 2026

(54) DOCK FOR LEGGED ROBOT AND RELATED TECHNOLOGY

(71) Applicant: Agility Robotics, Inc., Pittsburgh, PA (US)

(72) Inventors: David Matten, Mountain View, CA (US); Daniel Fradl, Corvallis, OR (US); Juan Cevallos Palomeque, Portland, OR (US); Ryan Schwendeman, Lake Oswego, OR (US)

(21) Appl. No.: 19/292,718

(22) Filed: Aug. 6, 2025

Related U.S. Application Data
(60) Provisional application No. 63/801,281, filed on May 7, 2025.

(51) Int. Cl. B25J 9/00; B25J 19/00; B62D 57/032

(52) U.S. Cl. CPC B25J 9/0009; B25J 19/005; B62D 57/032

(57) ABSTRACT

A system in accordance with at least some embodiments of the present technology includes a robot and a dock operably associated with one another. The system is transitionable between undocked and docked states. The robot includes a torso and defines an anterior-posterior dimension, a superior-inferior dimension, and a lateral dimension perpendicular to one another. At the torso, the robot includes a robot hanger, a robot electrode, and a battery. The dock defines a dock depth, a dock height, and a dock width parallel to the anterior-posterior dimension, the superior-inferior dimension, and the lateral dimension, respectively, when the system is in the docked state. The dock includes a dock hanger and a dock electrode configured to contact the robot hanger and the robot electrode, respectively, when the system is in the docked state. The dock electrode is spaced apart from the dock hanger along the dock height.

### CROSS-REFERENCE TO RELATED APPLICATION

This claims the benefit of U.S. Provisional Application No. 63/801,281 filed May 7, 2025. The foregoing application is incorporated herein by reference in its entirety. To the extent the foregoing application or any other material incorporated by reference conflicts with the present disclosure, the present disclosure controls.

### TECHNICAL FIELD

The present technology relates to docking legged robots, such as to facilitate charging, maintenance, and/or storage of the robots.

### BACKGROUND

Much of the work that humans currently perform is amenable to automation using robotics. For example, large numbers of human workers currently focus on executing actions that require little or no reasoning, such as predefined relocations of items and containers at order-fulfillment centers. Such actions may occur millions of times a day at a single order-fulfillment center and billions of times a day across a network of order-fulfillment centers. Human effort would be better applied to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1 is a perspective view of a system in accordance with at least some embodiments of the present technology.

FIGS. 2 and 3 are a side profile view and a front profile view, respectively, of a dock of the system of FIG. 1.

FIG. 4 is a perspective view of an upper portion of the dock of the system of FIG. 1.

FIGS. 5 and 6 are enlargements of portions of FIGS. 2 and 3, respectively.

FIG. 7 is an exploded perspective view of the upper portion of the dock of the system of FIG. 1.

FIG. 8 is a perspective view of a dock electrode of the dock of the system of FIG. 1.

FIG. 9 is an enlargement of a portion of FIG. 7.

FIG. 10 is a front profile view of the robot of the system of FIG. 1.

FIGS. 11 and 12 are a back profile view and a side profile view, respectively, of a torso of the robot of the system of FIG. 1.

FIGS. 13, 14 and 15 are a first perspective view, a second perspective view, and a front profile view of selected heat-transfer-related structures of the robot of the system of FIG. 1.

FIG. 16 is a cross-sectional view of the selected heat-transfer-related structures of the robot of the system of FIG. 1 taken along the line A-A in FIG. 15.

FIG. 17 is an enlargement of a portion of FIG. 16.

FIG. 18 is a view corresponding to FIG. 17 showing selected heat-transfer-related structures of a robot of another system in accordance with at least some embodiments of the present technology.

FIGS. 19 and 20 are a perspective view and a top plan view, respectively, of selected docking-related structures of the system of FIG. 1.

FIG. 21 is a cross-sectional side profile view of the selected docking structures of the system of FIG. 1 taken along the line B-B in FIG. 20.

FIG. 22 is a side profile view of the system of FIG. 1 at a first time during a transition of the system from an undocked state to a docked state.

FIG. 23 is a cross-sectional side profile view of the selected docking structures of the robot and the dock of the system of FIG. 1 taken along the line B-B in FIG. 20 at the first time during the transition of the system from the undocked state to the docked state.

FIG. 24 is a side profile view of the system of FIG. 1 at a second time during the transition of the system from the undocked state to the docked state.

FIG. 25 is a cross-sectional side profile view of the selected docking structures of the robot and the dock of the system of FIG. 1 taken along the line B-B in FIG. 20 at the second time during the transition of the system from the undocked state to the docked state.

FIG. 26 is a side profile view of the system of FIG. 1 at a third time during the transition of the system from the undocked state to the docked state.

FIG. 27 is a cross-sectional side profile view of the selected docking structures of the robot and the dock of the system of FIG. 1 taken along the line B-B in FIG. 20 at the third time during the transition of the system from the undocked state to the docked state.

FIG. 28 is a block diagram corresponding to a method in accordance with at least some embodiments of the present technology.

FIG. 29 is a block diagram depicting selected electrical, computer, and other features of a system in accordance with at least some embodiments of the present technology.

FIG. 30 is a block diagram depicting selected software architecture and other features of the system of FIG. 29.

### DETAILED DESCRIPTION

Disclosed herein are robots, docks, and associated devices, systems, and methods. Systems in accordance with at least some embodiments of the present technology include innovative features related to retention, alignment, charging, and heat-transfer, among other things. A system in accordance with at least some embodiments of the present technology includes a robot and a dock operably associated with one another. The system can be configured to transition between an undocked state in which the robot and the dock are out of contact with one another and a docked state in which the robot and the dock are in contact with one another. In at least some cases, the robot and the dock are electrically connected to one another when the system is in the docked state. Furthermore, the dock can support at least some (e.g., all) of the robot's weight when the system is in the docked state. For example, the robot can partially or completely hang from the dock. While docked, the robot can recharge via the dock, receive maintenance, or simply be stowed.

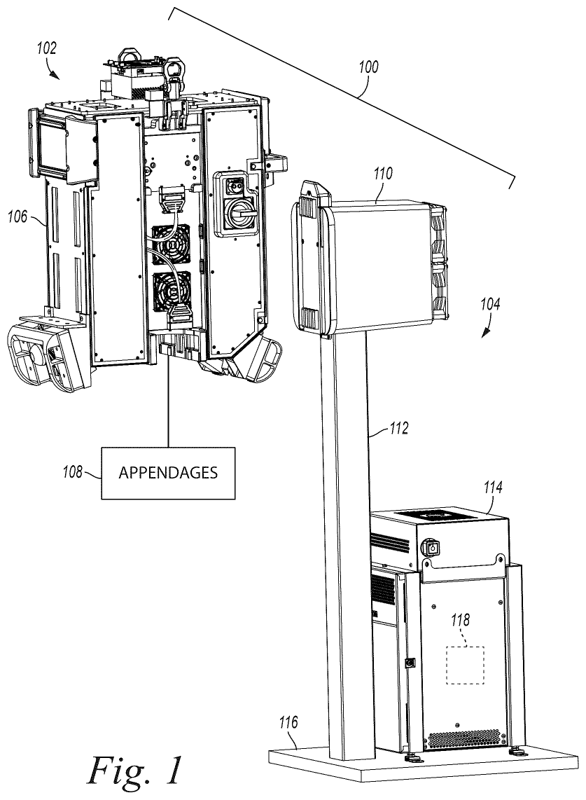

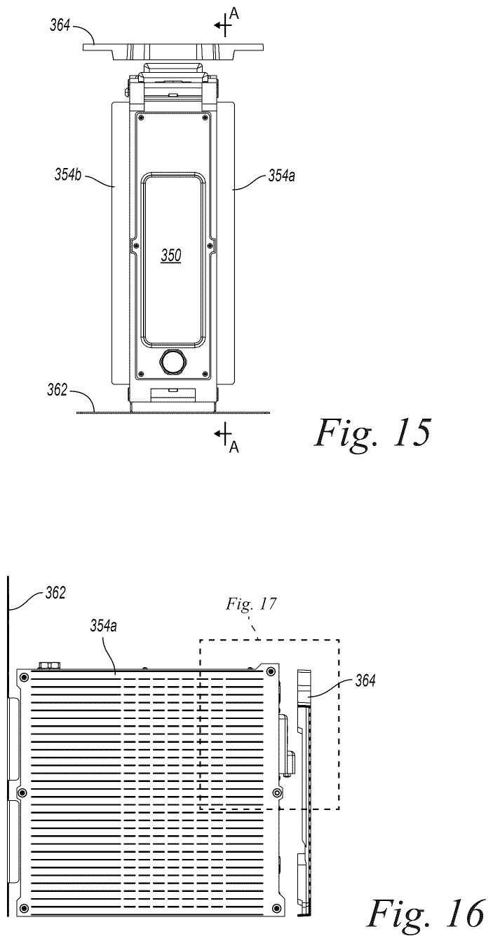

Features of robots, docks, and associated devices, systems, and methods in accordance with various embodiments of the present technology are further described below with reference to FIGS. 1-30. Although methods, devices, and systems may be described herein primarily or entirely in the context of bimanual, bipedal robots, other contexts are within the scope of the present technology. For example, suitable features of described methods, devices, and systems can be implemented in the context of robots with one arm, in the context of robots with more than two arms, and/or in the context of non-legged robots. The word “bipedal” as used herein may be replaced with “mobile” to encompass non-bipedal counterparts within the present technology unless the context clearly indicates otherwise. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Systems

FIG. 1 is a perspective view of a system 100 in accordance with at least some embodiments of the present technology. The system 100 can include a robot 102 and a dock 104 operably associated with one another. The system 100 can be transitionable between an undocked state in which the robot 102 and the dock 104 are spaced apart from one another and a docked state in which the robot 102 and the dock 104 are in contact with one another. The robot 102 can include a torso 106 and appendages 108 (shown schematically) carried by the torso 106. The dock 104 can include a head 110, a post 112 carrying the head 110, and a console 114 adjacent to the post 112. The dock 104 can further include a platform 116 underlying the other components. In at least some cases, the post 112 is welded or bolted to the platform 116. At the console 114, the dock 104 can include a transformer and/or one or more other power-supply components 118 (shown schematically) configured to facilitate electrical charging of the robot 102 via the dock 104. Relatedly, the dock 104 can include wiring (not shown) extending between the power-supply components 118 and the head 110 via the post 112. Furthermore, the dock 104 can include one or more fiducials (not shown; e.g., one or more April tags) that facilitate location of the dock 104 by the robot 102.

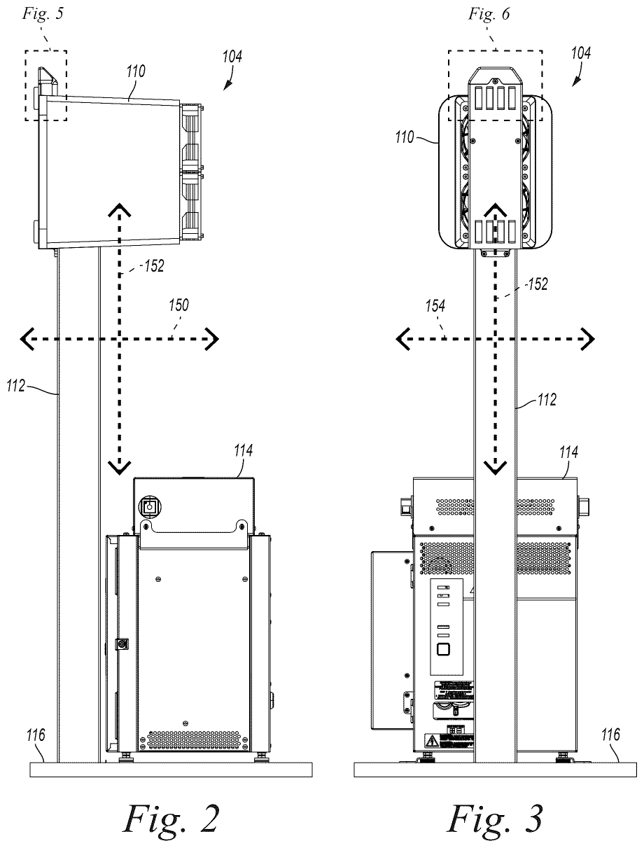

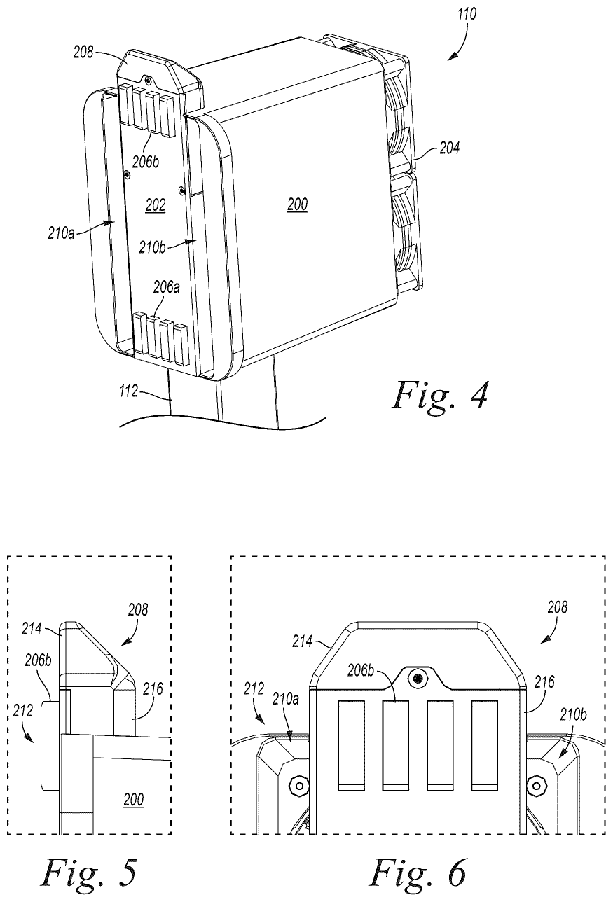

FIGS. 2 and 3 are a side profile view and a front profile view, respectively, of the dock 104. As shown in FIGS. 2 and 3, the dock 104 can define a dock depth 150, a dock height 152, and a dock width 154 perpendicular to one another. FIG. 4 is a perspective view of an upper portion of the dock 104 along the dock height 152. FIGS. 5 and 6 are enlargements of portions of FIGS. 2 and 3, respectively. With reference now to FIGS. 1-6 together, the dock 104 can include a housing 200 at the head 110. The post 112 can extend upward into the housing 200 along the dock height 152. The dock 104 can also include an electrode carrier 202 and a cooler 204 at opposite respective end portions of the housing 200 along the dock depth 150. In at least some cases, the cooler 204 is an air mover. The dock 104 can further include dock electrodes 206a, 206b carried by the electrode carrier 202. The dock electrodes 206a, 206b can be centrally positioned along the dock width 154 and spaced apart from one another along the dock height 152. The dock can define ports 210a, 210b at opposite respective sides of the electrode carrier 202 along the dock width 154. The ports 210a, 210b can be relatively tall and narrow. For example, an average extent of the port 210a along the dock height 152 can be at least two times (e.g. at least four times) an average extent of the port 210a along the dock width 154. Similarly, an average extent of the port 210b along the dock height 152 can be at least two times (e.g. at least four times) an average extent of the port 210b along the dock width 154. These and/or other shape features of the ports 210a, 210b can promote high-velocity airflow across an expansive region along the dock height 152. This can be useful for cooling a battery that dissipates heat bilaterally, as discussed below. Moreover, the placements of the ports 210a, 210b on opposite respective sides of the electrode carrier 202 along the dock width 154 can facilitate structural support of the electrode carrier 202 via the post 112. Other advantages of the ports 210a, 210b in addition to or instead of the foregoing are also possible.

The dock 104 can further include a dock hanger 208. The dock electrodes 206a, 206b and the dock hanger 208 can be between the ports 210a, 210b along the dock width 154. The dock 104 can include a main body 212 at which it carries the dock electrodes 206a, 206b and at which it defines the ports 210a, 210b. The dock hanger 208 can protrude upward from the main body 212 along the dock height 152 when the system 100 is in the docked state. In at least some cases, the dock hanger 208 is relatively wide and shallow. For example, an average extent of the dock hanger 208 along the dock width 154 can be at least two times an average extent of the dock hanger 208 along the dock depth 150. In these and other cases, the dock hanger 208 can include a first portion 214 and a second portion 216 at different respective elevations along the dock height 152 and with different respective shape features. The second portion 216 of the dock hanger 208 can be between the first portion 214 of the dock hanger 208 and the main body 212. In at least some cases, an average extent of the first portion 214 of the dock hanger 208 along the dock depth 150 decreases at increasing distance from the main body 212 along the dock height 152. In addition or alternatively, an average extent of the first portion 214 of the dock hanger 208 along the dock width 154 can decrease at increasing distance from the main body 212 along the dock height 152. Also in addition or alternatively, the first portion 214 of the dock hanger 208 can be more symmetrical along the dock width 154 than it is along the dock depth 150. As further described below, these and/or other shape features of the dock hanger 208 can facilitate alignment of the robot 102 with the dock 104 and/or other aspects of successfully transitioning the system 100 from the undocked state to the docked state.

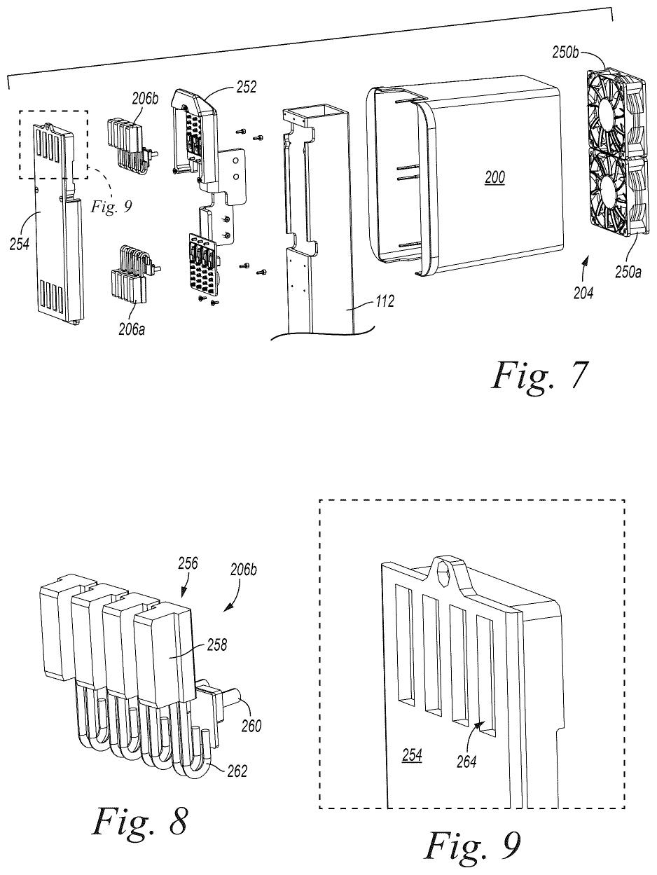

FIG. 7 is an exploded perspective view of the upper portion of the dock 104. FIG. 8 is a perspective view of the dock electrode 206a. FIG. 9 is an enlargement of a portion of FIG. 7. With reference to FIGS. 1-9 together, the cooler 204 can include fans 250a, 250b neighboring one another along the dock height 152. The cooler 204 can be configured to draw air into the housing 200 via the ports 210a, 210b and/or to push air out of the housing 200 via the ports 210a, 210b. In other embodiments, a counterpart of the cooler 204 can have other suitable features. For example, a counterpart of the cooler 204 can include one or more compressed air ports, a single fan, an array of more than two fans, etc. With reference again to the illustrated embodiment, the ports 210a, 210b can promote airflow around the portion of the post 112 within the housing 200 without causing the head 110 to be unduly large along the dock width. Relatedly, airflow along the dock depth 150 can facilitate close, side-by-side placement of the dock 104 and other docks (not shown) in an environment. This can be desirable for efficient space utilization in the environment.

As discussed in detail below, the dock 104 can be configured to carry significant weight via the dock hanger 208 when the system 100 is in the docked state. Features of the dock 104 can promote efficient transfer of this weight to the post 112. In at least some cases, the dock hanger 208 is at an upper portion of the electrode carrier 202. The electrode carrier 202 can include a crown 252 that forms at least some of the first portion 214 of the dock hanger 208 and extends downward therefrom along the dock height 152. In these and other cases, the crown 252 can attach (e.g., bolt) directly to the post 112. The crown 252 is configured to provide a robust structural connection between the dock hanger 208 and the post 112. Relatedly, the crown 252 can be made of metal, such as steel or aluminum. In other cases, a counterpart of the crown 252 can be offset from the post 112. With reference again to FIGS. 1-9, the electrode carrier 202 can also include a dielectric panel 254 that directly contacts the dock electrodes 206a, 206b. The dielectric panel 254 can be made of rigid plastic, such as polyimide. The dock electrode 206a can be spaced apart from the dock hanger 208 along the dock height 152. The dock electrode 206b can be at the dock hanger. In addition or alternatively, the dock electrode 206b can be between the dock electrode 206a and the dock hanger 208 along the dock height 152.

In the illustrated example, the dock electrodes 206a, 206b individually include four electrode modules 256 (one labeled in FIG. 8) arranged side-by-side along the dock width 154. The individual electrode modules 256 can include a contact block 258, a connector 260, and a lead 262 extending therebetween. The individual electrodes can also include a spring (not shown) configued to resiliently bias the contact block 258 relative to the dielectric panel. The dielectric panel 254 can define openings 264 (one labeled in FIG. 9) through which the contact blocks 258 extend, respectively. As with other portions of the electrode carrier 202, the dielectric panel 254 can be between the ports 210a, 210b. Furthermore, the dielectric panel 254 can extend between the dock electrodes 206a, 206b. In at least some cases, the dielectric panel 254 occupies at least 75% (e.g., at least 95%) of a total area between the ports 210 a, 210 b and between the dock electrodes 206a, 206b. In addition or alternatively, the spacing between the dock electrodes 206a, 206b along the dock height 152 can be significant, such as at least 200% of an extent of the dock electrode 206a along the dock height 152. This can be useful to reduce the likelihood of an unintentional electrical connection of the dock electrodes 206a, 206b to one another and/or have other advantages. Moreover, in other examples, counterparts of the dock electrodes 206a, 206b and the dielectric panel 254 can have other suitable forms, arrangements, etc. For example, counterparts of the dock electrodes 206a, 206b can individually include a single, large contact block rather than the illustrated sets of contact blocks 258.

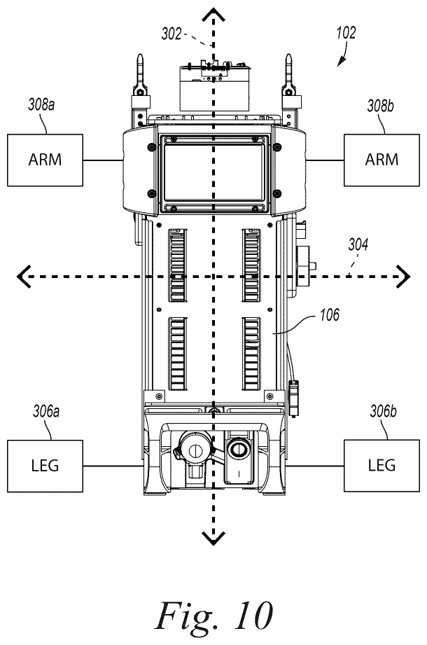

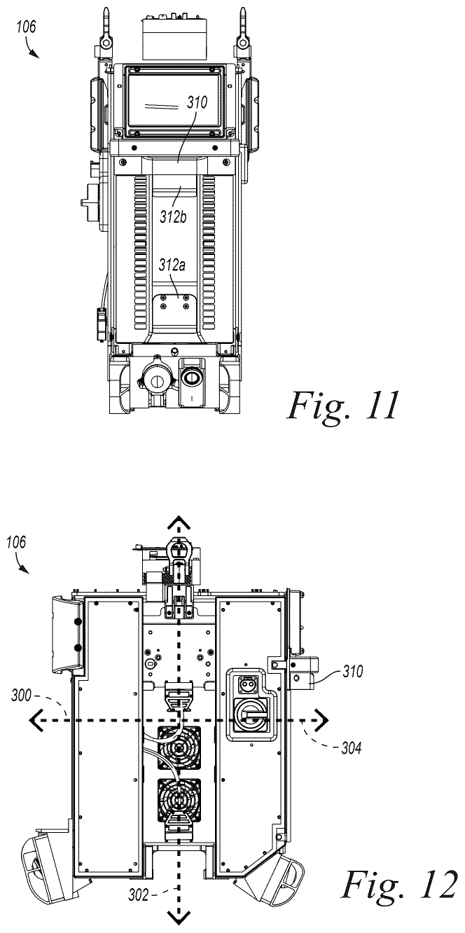

FIG. 10 is a front profile view of the robot 102. FIGS. 11 and 12 are a back profile view and a side profile view, respectively, of the torso 106. With reference to FIGS. 1-12 together, the robot 102 can define an anterior-posterior dimension 300, a superior-inferior dimension 302, and a lateral dimension 304 perpendicular to one another. When the system 100 is in the docked state, the dock depth 150, the dock height 152, and the dock width 154 can be parallel to the anterior-posterior dimension 300, the superior-inferior dimension 302, and the lateral dimension 304, respectively. Among the appendages 108 (FIG. 1), the robot 102 can include legs 306a, 306b (shown schematically in FIG. 10). The legs 306a, 306b can be connected to the torso 106 via an inferior region of the torso 106, e.g., at an inferiormost 25% of the torso 106 along the superior-inferior dimension 302. The robot 102 can be configured to ambulate (e.g., bipedally) via the legs 306a, 306b. Also among the appendages 108, the robot 102 can include arms 308a, 308b (also shown schematically in FIG. 10). The arms 308a, 308b can be connected to the torso 106 via a superior region of the torso 106, e.g., at a superiormost 25% of the torso 106 along the superior-inferior dimension 302. The robot 102 can be configured to manipulate objects (e.g., bimanually) via the arms 308a, 308b. The legs 306a, 306b and the arms 308a, 308b can define kinematic chains. The kinematic chains corresponding to the arms 308a, 308b, individually, for example, can provide at least five degrees of freedom, such as exactly five or exactly six degrees of freedom. In these and other cases, the kinematic chains corresponding to the legs 306a, 306b, individually, can provide at least four degrees of freedom, such as exactly four, exactly five, or exactly six degrees of freedom. As parts of the arms 308a, 308b, the robot 102 can include end effectors (not shown) at distalmost portions of the corresponding kinematic chains. Similarly, as parts of the legs 306a, 306b, the robot 102 can include feet (not shown) at distalmost portions of the corresponding kinematic chains.

In at least some cases, the robot 102 includes structures resembling human anatomy with respect to the features, positions, and/or other characteristics of such structures. In these and other cases, the robot 102 can define a midsagittal plane about which it is bilaterally symmetrical. Furthermore, the robot 102 can be configured for bipedal locomotion similar to that of a human. Counterparts of the robot 102 can have other suitable forms and features. For example, a counterpart of the robot 102 can have a non-humanoid form. Still further, a counterpart of the robot 102 can be asymmetrical or have symmetry other than bilateral. Also, a counterpart of the robot 102 can be configured for non-bipedal locomotion. For example, a counterpart of the robot 102 can be configured for another type of legged locomotion (e.g., quadrupedal locomotion, octopedal locomotion, etc.) and/or non-legged locomotion (e.g., wheeled locomotion, continuous-track locomotion, etc.).

With reference again to the illustrated embodiment, the robot 102 can include a robot hanger 310 configured to interact with the dock hanger 208 as the system 100 moves to and from the docked state. The robot hanger 310 can extend posteriorly from the torso 106. Furthermore, the robot hanger 310 can be connected to the torso 106 via a superior region of the torso 106, e.g., at a superiormost 25% of the torso 106 along the superior-inferior dimension 302. In other embodiments, a counterpart of the robot hanger 310 can extend anteriorly from the torso 106. In still other embodiments, a counterpart of the robot hanger 310 can be connected to a different portion of the robot 102, such as a head (not shown) of the robot 102. With reference again to the illustrated embodiment, the dock hanger 208 and the robot hanger 310 can be configured to contact one another and to form a secure connection when the system 100 is in the docked state. Relatedly, the dock hanger 208 and the robot hanger 310 can be configured to form a post-and-socket connection when the system 100 is in the docked state. In at least some cases, the dock hanger 208 and the robot hanger 310 are configured to urge the torso 106 into alignment with the dock 104 along the lateral dimension 304 as the system 100 transitions from the undocked state to the docked state. In these and other cases, the dock hanger 208 and the robot hanger 310 can define a fulcrum when the system 100 is in the docked state.

The robot 102 can further include robot electrodes 312a, 312b at a posterior region of the torso 106 along the anterior-posterior dimension 300. The dock electrode 206a and the robot electrode 312a can be configured to contact one another when the system 100 is in the docked state. Similarly, the dock electrode 206b and the robot electrode 312b can be configured to contact one another when the system 100 is in the docked state. The robot electrode 312b can be superiorly spaced apart from the robot electrode 312a along the superior-inferior dimension 302. In addition or alternatively, the robot electrode 312a can be at an inferior region of the torso 106, e.g., at an inferiormost 25% of the torso 106 along the superior-inferior dimension 302. Furthermore, when the system 100 is in the docked state and the dock hanger 208 and the robot hanger 310 define a fulcrum that redirects a gravity force acting on the torso 106, this redirected gravity force can increase a contact force between the robot electrode 312a and the dock electrode 206a. The spacing of the robot electrodes 312a, 312b along the superior-inferior dimension 302 can promote this interaction. Furthermore, this spacing and the corresponding spacing of the dock electrodes 206a, 206b along the dock height 152 can reduce the likelihood of unintentional contact between the robot electrode 312a and the dock electrode 206b and reduce the likelihood of unintentional contact between the robot electrode 312b and the dock electrode 206a as the system 100 transitions from the undocked state to the docked state.

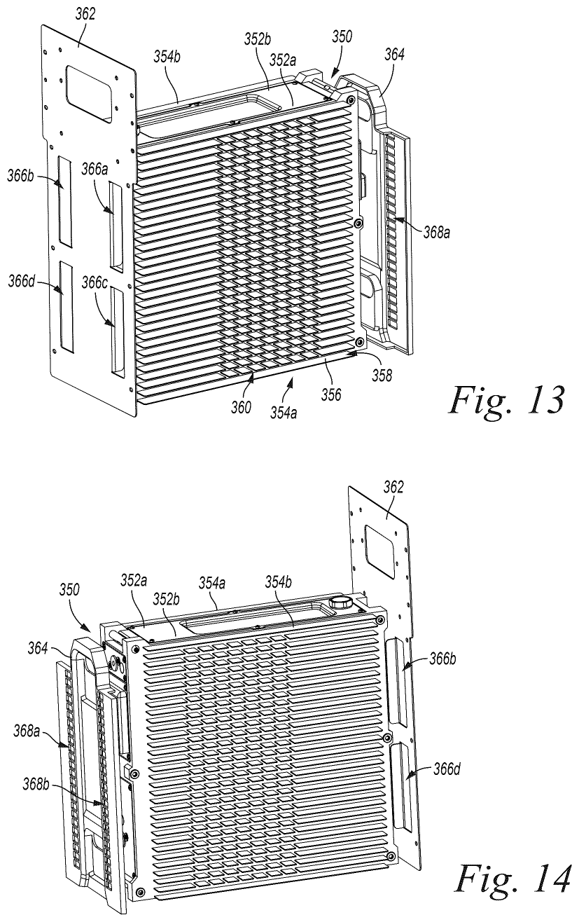

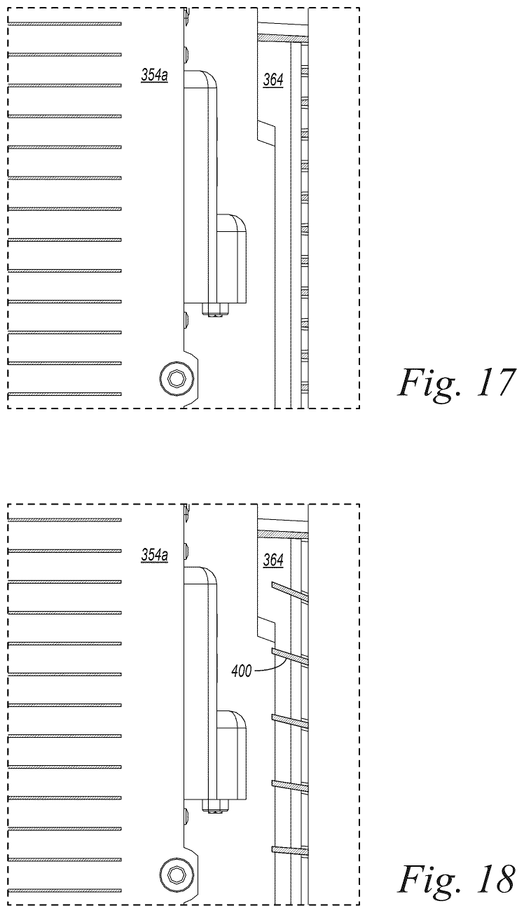

FIGS. 13, 14, 15 and 16 are a first perspective view, a second perspective view, a front profile view, and a side profile view of selected heat-transfer-related structures of the robot 102. FIG. 17 is an enlargement of a portion of FIG. 16. With reference to FIGS. 1-17 together, the robot 102 can include a battery 350 at the torso 106. The battery 350 can be configured to charge via the robot electrodes 312a, 312b. The robot 102 can include leads (not shown) extending between the battery 350 and the robot electrodes 312a, 312b. An average extent of the battery 350 in the anterior-posterior dimension 300 can be greater (e.g., at least 50% greater, at least 100% greater, at least 150% greater, etc.) than an average extent of the battery 350 in the lateral dimension 304. Furthermore, the battery 350 can include side portions 352a, 352b opposite to one another along the lateral dimension 304. The robot 102 can include heat sinks 354a, 354b at the side portions 352a, 352b of the battery 350, respectively. The battery 350 can be configured to dissipate heat at least primarily bilaterally. The heat sinks 354a, 354b can include fins 356 (one labeled in FIG. 13) extending outward from the battery 350 along the lateral dimension 304. In the illustrated example, the individual fins 356 are elongate, parallel to one another, and substantially parallel to (e.g., within 15 degrees of parallel to) the anterior-posterior dimension 300. The fins 356 can define channels 358 (one labeled in FIG. 13) also substantially parallel to (e.g., within 15 degrees of parallel to) the anterior-posterior dimension 300. In at least some cases, the fins 356 further define gaps 360 (one labeled in FIG. 13) configured to permit airflow between the channels 358. In other examples, counterparts of the heat sinks 354a, 354b can have other suitable forms. For example, counterparts of the heat sinks 354a, 354b can include staggered arrays (e.g., quincunxes) and/or non-staggered arrays of posts or other structures instead of or in addition to the fins 356. Furthermore, counterparts of the fins 356 can be louvres configured to direct airflow in curved rather than straight paths.

With reference again to the illustrated embodiment, the robot 102 can include features that promote airflow across the heat sinks 354a, 354b in the anterior-posterior dimension 300. As shown in FIGS. 13-16, the robot 102 can include an anterior plate 362 and a posterior plate 364 at anterior and posterior regions, respectively, of the torso 106. At the anterior plate 362, the robot 102 can include anterior vents 366a-366d. Similarly, at the posterior plate 364, the robot 102 can include posterior vents 368a, 368b. The posterior vent 368a can be configured to align with the port 210a when the system 100 is in the docked state. The port 210a can be configured to allow air movement between the heat sink 354a and the cooler 204 when the system 100 is in the docked state. Similarly, the posterior vent 368b can be configured to align with the port 210b when the system 100 is in the docked state. The port 210b can be configured to allow air movement between the heat sink 354b and the cooler 204 when the system 100 is in the docked state. In at least some cases, the system 100 includes features configured to reduce or eliminate lateral airflow at an interface between the robot 102 and the dock 104 when the system 100 is in the docked state. For example, the robot 102 can include rubber gaskets (not shown) at respective perimeter regions (e.g., outer perimeter regions along the lateral dimension 304) of the posterior vents 368a, 368b. In addition or alternatively, the dock 104 can include rubber gaskets (also not shown) at respective perimeter regions (e.g., outer perimeter regions along the dock width 154) of the ports 210a, 210b.

FIG. 18 is a view corresponding to FIG. 17 showing selected heat-transfer-related structures of a robot of another system in accordance with at least some embodiments of the present technology. In the system shown in FIG. 17, the posterior plate 364 includes baffles 400 (one labeled) at the posterior vents 368a, 368b. Other portions of the system shown in FIG. 17 can be the same as or similar to corresponding portions of the system 100. With reference to FIGS. 1-18 together, the baffles 400 can be configured to increase a distribution of the air along the superior-inferior dimension 302 as the air moves from the cooler 204 toward the heat sinks 354a, 354b. For example, baffles 400 at increasingly greater distances from a midpoint of the posterior vent 368a along the superior-inferior dimension 302 can tilt off parallel to the anterior-posterior dimension 300 at increasingly greater angles. Similarly, baffles 400 at increasingly greater distances from a midpoint of the posterior vent 368b along the superior-inferior dimension 302 can tilt off parallel to the anterior-posterior dimension 300 at increasingly greater angles.

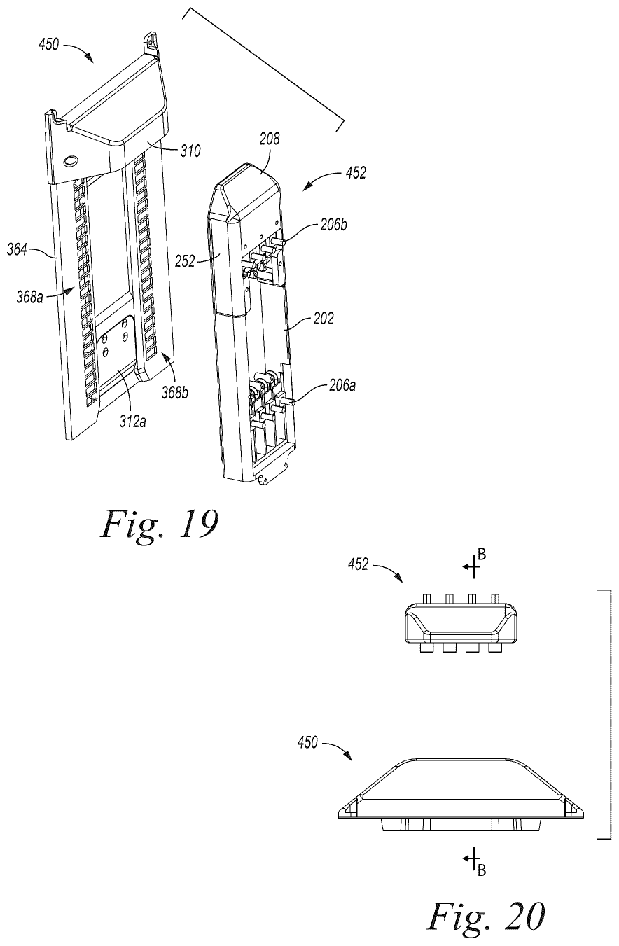

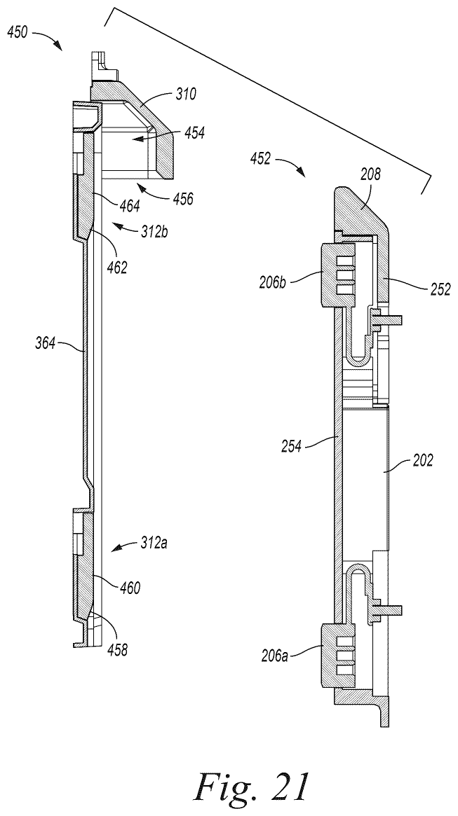

FIGS. 19 and 20 are a perspective view and a top plan view, respectively, of selected docking-related structures of the system 100. FIG. 21 is a cross-sectional side profile view of the selected docking structures of the system 100 taken along the line B-B in FIG. 20. The selected docking-related structures include an assembly 450 of the robot 102 and an assembly 452 of the dock 104. As parts of the assembly 450, the system 100 and the robot 102 can include the robot hanger 310, the robot electrodes 312a, 312b, and the posterior plate 364. As parts of the assembly 452, the system 100 and the dock 104 can include the electrode carrier 202, the dock electrodes 206a, 206b, and the dock hanger 208. As shown in FIG. 21 and with reference to FIG. 10, the robot hanger 310 can include a socket 454 that opens inferiorly along the superior-inferior dimension 302. Relatedly, the socket 454 can define an inferior opening 456 along the superior-inferior dimension 302. In at least some cases, the robot electrodes 312a, 312b include shape features that promote smooth engagement with the dock electrodes 206a, 206b, respectively, during a transition of the system 100 from the undocked state to the docked state. As shown in FIG. 21 and with reference to FIG. 10, the robot electrode 312a can include a ramp 458 and a pad 460 superior to the ramp 458 in the superior-inferior dimension 302. Similarly, the robot electrode 312b can include a ramp 462 and a pad 464 superior to the ramp 462 in the superior-inferior dimension 302. The ramps 458, 462 can be configured for transitory contact with the dock electrodes 206a, 206b, respectively, as the system 100 transitions from the undocked state to the docked state. In at least some cases, during transitory contact, the ramps 458, 462 cause a wiping motion against the dock electrodes 206a, 206b, which, as mentioned above, can be the spring-loaded. This can help to clean the interfaces between the dock electrodes 206a, 206b and the robot electrodes 312a, 312b, thereby promoting reliable electrical contact. The pads 460, 464 can be configured for sustained contact with the dock electrodes 206a, 206b, respectively, as the system 100 transitions from the undocked state to the docked state.

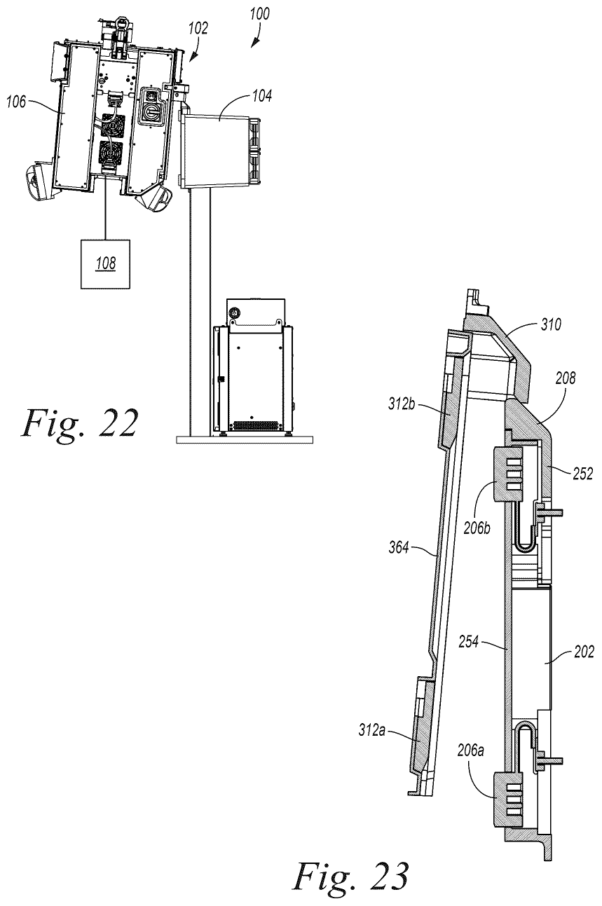

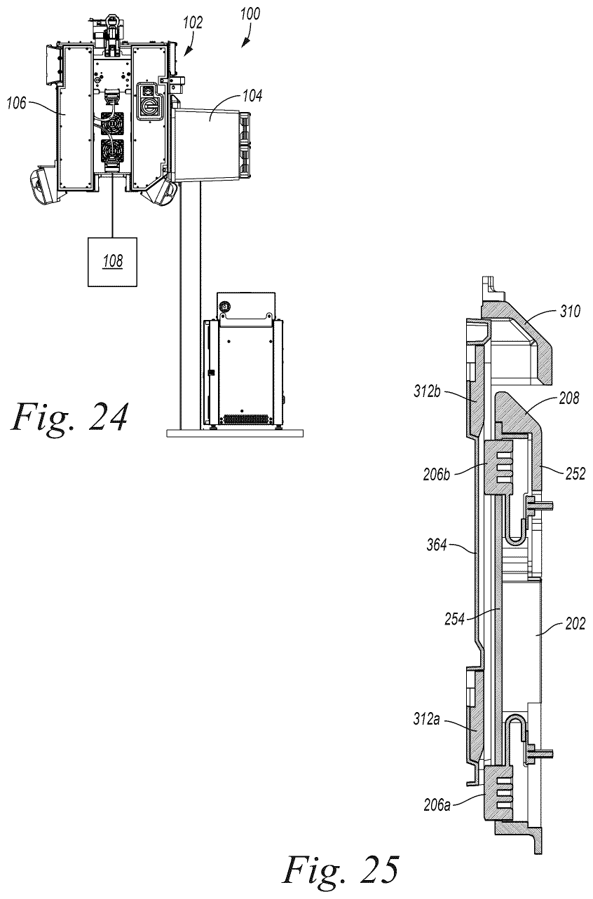

FIG. 22 is a side profile view of the system 100 at a first time during a transition of the system 100 from an undocked state to a docked state. FIG. 23 is a cross-sectional side profile view of the assemblies 450, 452 taken along the line B-B in FIG. 20 at the first time. Before the first time, the robot 102 and the dock 104 can be out of contact with one another. The robot 102 and the dock 104 at the first time can be in contact with one another. Also at the first time and immediately therebefore, the torso 106 can be tilted such that a superior portion of the assembly 450 tends to contact the dock hanger 208 before an inferior portion of the assembly 450 contacts the dock hanger 208. FIG. 24 is a side profile view of the system 100 at a second time during the transition. FIG. 25 is a cross-sectional side profile view of the assemblies 450, 452 taken along the line B-B in FIG. 20 at the second time. From the first time to the second time during the transition, the torso 106 can tilt such that the superior-inferior dimension 302 (FIG. 10) moves closer to being parallel to the dock height 152 (FIG. 2). In other cases, the tilting at the first time can be omitted. For example, torso 106 can initially contact the dock 104 with the superior-inferior dimension 302 substantially parallel (e.g., within five degrees of parallel) to the dock height 152

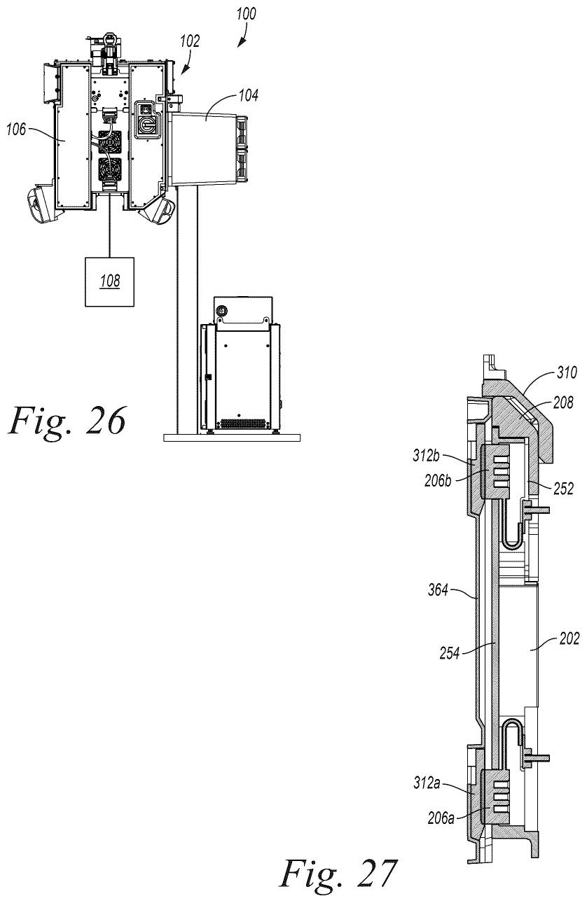

FIG. 26 is a side profile view of the system 100 at a third time during the transition. FIG. 27 is a cross-sectional side profile view of the assemblies 450, 452 taken along the line B-B in FIG. 20 at the third time. From the second time to the third time during the transition, the torso 106 can move relative to the dock 104 inferiorly along the superior-inferior dimension 302 (FIG. 10). This can cause the dock hanger 208 to insert into the socket 454 via the inferior opening 456. As discussed above, shape features of the robot hanger 310 and/or of the dock hanger 208 can cause the torso 106 to move into alignment with the dock 104 along dock width 154 and/or into close contact with the dock 104 along the dock depth 150. In at least some cases, as the torso 106 moves relative to the dock 104, the robot electrode 312a first contacts the dock electrode 206a via the ramp 458 and then moves into sustained contact with the dock electrode 206a via the pad 460. Similarly, the robot electrode 312b can first contact the dock electrode 206b via the ramp 462 and then move into sustained contact with the dock electrode 206b via the pad 464.

### Examples of Methods

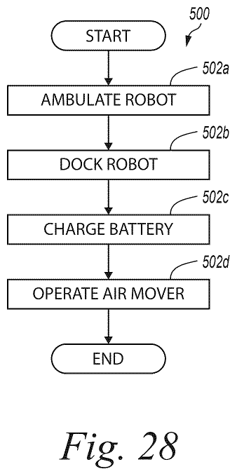

FIG. 28 is a block diagram corresponding to a method 500 in accordance with at least some embodiments of the present technology. Although the method 500 will be described primarily or entirely in the context of the system 100, it should be understood that suitable features of the method 500 can likewise be practiced in other contexts in accordance with various embodiments of the present technology. With reference to FIGS. 1-28 together, the method 500 can include ambulating the robot 102 toward the dock 104 (block 502a) while the system 100 is in an undocked state. In at least some cases, this includes moving (e.g., ambulating) the robot 102 retrograde toward the dock 104. Relative to antegrade movement, retrograde movement for docking can have certain advantages, such as improved legibility, reduced interference with anterior structures of the robot 102, reduced interference with anteriorly carried payloads, etc. In other embodiments, however, a counterpart of the robot 102 can move antegrade toward the dock 104, e.g., when the a counterpart of the robot hanger 310 extends anteriorly from the torso 106.

The method 500 can further include docking the robot 102 (block 502b). This can include any of the operations discussed above in connection with transitioning the robot 102 from the undocked state to the docked state. Docking the robot 102 can occur at the dock 104 after ambulating the robot 102 toward the dock 104. Furthermore, docking the robot 102 can include contacting the robot hanger 310 and the dock hanger 208. In at least some cases, docking the robot 102 includes receiving the dock hanger 208 at the socket 454 via the inferior opening 456. In these and other cases, while docking the robot 102, interaction between the robot hanger 310 and the dock hanger 208 can urge the robot electrodes 312a, 312b into alignment with the dock electrodes 206a, 206b, respectively, along the lateral dimension 304. Correspondingly, the method 500 can include urging the torso 106 into alignment with the dock 104 along the lateral dimension 304 via interaction between the robot hanger 310 and the dock hanger 208. Furthermore, docking the robot 102 can include moving the legs 306a, 306b to transfer at least most (e.g., all) of a total weight of the robot 102 to the dock 104. In another example, a counterpart of the robot 102 can include a variable-height mobility platform (e.g., a wheeled mobility platform) instead of the legs 306a, 306b. In this example, docking the counterpart robot can include lowering the platform.

With reference again to the illustrated example, during the method 500 and while the system 100 is in the docked state, the robot hanger 310 and the dock hanger 208 can define a fulcrum that redirects a gravity force acting on the robot 102 to increase a contact force between the robot 102 and the dock 104. As discussed above, this contact force may act on an interface between the robot electrode 312a and the dock electrode 206a and/or on an interface between the robot electrode 312b and the dock electrode 206b. The increased contact force can increase a reliability of an electrical connection between the robot electrode 312a and the dock electrode 206a, increase a reliability of an electrical connection between the robot electrode 312b and the dock electrode 206b, and/or have other advantages.

The method 500 can also include charging the battery 350 (block 502c) after docking the robot 102 and while the system 100 is in the docked state. Charging the battery 350 can occur via a changing interface between the robot electrode 312a and the dock electrode 206a and/or via a changing interface between the robot electrode 312b and the dock electrode 206b. While charging, the battery 350 may generate significant heat. The battery 350 may also generate heat while operating before charging. Features of the system 100 can promote the efficient dissipation of heat generated by the robot 102 at the battery 350 and elsewhere. As shown in FIG. 28, the method 500 can include operating the cooler 204 (block 502d) while the system 100 is in the docked state. In at least some cases, operating the cooler 204 and charging the battery 350 occur at the same time. Operating the cooler 204 can cause air to move via the port 210a and across the heat sink 354a. Similarly, operating the cooler 204 can cause air to move air via the port 210b and across the heat sink 354b. Furthermore, operating the cooler 204 can cause air to move through the anterior vents 366a-366d and the posterior vents 368a, 368b. Still further, operating the cooler 204 can cause air to move through regions within the dock 104 between the post 112 and opposite respective sides of the housing 200 along the dock width 154.

While operating the cooler 204, air can flow to and/or from the cooler 204. For example, at a given time, both fans 250a, 250b can pull air through the robot 102, both fans 250a, 250b can push air through the robot 102, the fan 250a can push air through the robot 102 while the fan 250b pulls air through the robot 102, or the fan 250a can pull air through the robot 102 while the fan 250b pushes air through the robot 102. In at least some cases, an average direction of all airflow through the robot 102 can be within 40 degrees (e.g., within 20 degrees) of parallel to the anterior-posterior dimension 300. In these and other cases, an average direction of all airflow through the dock 104 can be within 40 degrees (e.g., within 20 degrees) of parallel to the dock depth 150. These and/or other features of airflow through the robot 102 and/or through the dock 104 can be useful to promote efficient heat dissipation from the system 100. In at least some cases, heat dissipation away from the robot 102 along the dock depth 150 and the anterior-posterior dimension 300 tends to be less problematic than heat dissipation away from the robot 102 along the dock width 154 and the lateral dimension 304. For example, this directional feature can facilitate side-by-side placement of the system 100 and other systems in an environment such that the dock width 154 and corresponding dock widths of the docks of the other systems are parallel to one another. In these and other cases, heat dissipation along the dock depth 150 and along the anterior-posterior dimension 300 can reduce or eliminate disadvantageous heat transfer from the system 100 to neighboring systems and vice versa.

The method 500 can also include increasing a distribution of air along the superior-inferior dimension 302 while operating the cooler 204. This can occur as the air moves from the cooler 204 toward the heat sinks 354a, 354b. Moreover, increasing the distribution of air along the superior-inferior dimension 302 can occur via the baffles 400. Similarly, the method 500 can include decreasing a distribution of air along the superior-inferior dimension 302 while operating the cooler 204. This can occur as the air moves from the heat sinks 354a, 354b toward the cooler 204. Again, decreasing the distribution of air along the superior-inferior dimension 302 can occur via the baffles 400. Increasing and/or decreasing the distribution of air along the superior-inferior dimension 302 can be useful, for example, to at least partially compensate for flow-channel restriction along the superior-inferior dimension 302 at the ports 210a, 210b.

### Examples of Electrical, Computer, and Software Features

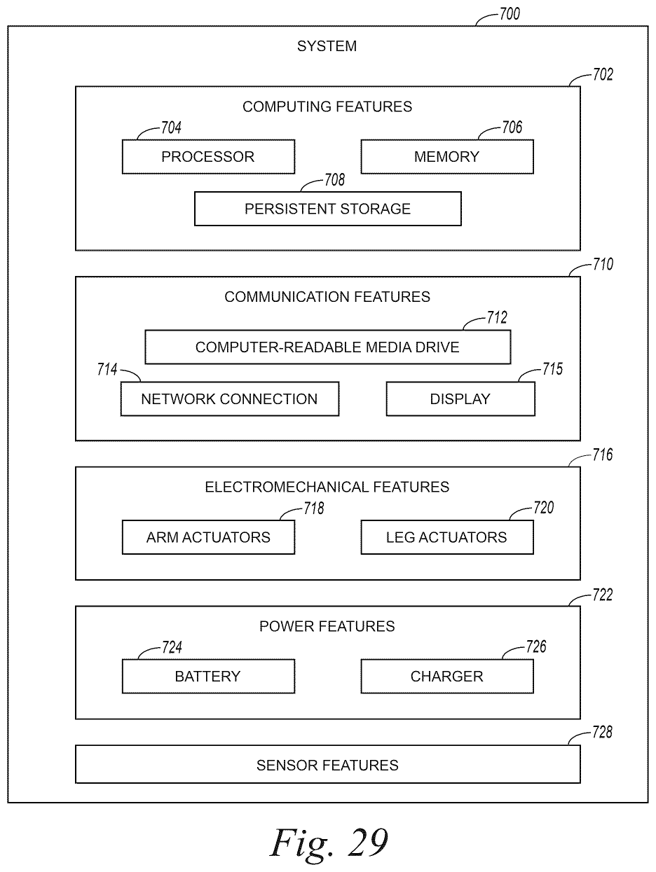

FIG. 29 is a block diagram depicting selected electrical, computer, and other features of a system 700 in accordance with at least some embodiments of the present technology. The system 700 can be part of the system 100 and vice versa. When suitable, operations described elsewhere in this disclosure can be implemented at least partially via the selected electrical, computer, and other portions of the system 700. As shown in FIG. 29, the system 700 can include computing features 702. The computing features 702 can include a processor 704, such as one or more general-purpose or special-purpose integrated circuits including digital logic gates for executing programs or for otherwise processing data. The computing features 702 can further include memory 706, such as one or more integrated circuits for storing data in use. The memory 706 can include a multithreaded program, an operating system including a kernel, device drivers, etc. The computing features 702 can further include persistent storage 708, such as a hard drive for persistently storing data. Examples of data that can be stored by the persistent storage 708 include diagnostic data, sensor data, configuration data, environmental data, and current-state data. The computing features 702 can collectively define a computer configured to manage, control, receive information from, deliver information to, and/or otherwise usefully interact with other features of the system 700.

The system 700 can further include communication features 710. The communication features 710 can include a computer-readable media drive 712 for reading computer programs and/or other data stored on computer-readable media. As one example, the computer-readable media drive 712 can be a flash-memory drive. The communication features 710 can further include a network connection 714 for connecting the robot 102 and the dock 104 to one another and/or to other devices and systems, such as other robots and/or other docks. The network connection 714 can be wired or wireless and can be via the Internet, a Local Area Network (LAN), a Wide Area Network (WAN), BLUETOOTH®, Wi-Fi®, a cellular-phone network, etc. The network connection 714 can include networking hardware, such as routers, switches, transmitters, receivers, computer-readable transmission media, etc. The communication features 710 can further include a display 715 (e.g., a touchscreen) and/or other suitable features for communicating with a user. The robot 102 can use the communication features 710 for internal and/or external operations. Examples of these operations include interacting with systems that provide contextual information about the environment in which the robot 102 operates and interacting with devices for changing operating conditions of the robot 102.

The system 700 can further include electromechanical features 716. The electromechanical features 716 can include arm actuators 718 and leg actuators 720 operably associated with respective joints of the arms 308a, 308b and the legs 306a, 306b. In addition or alternatively, the electromechanical features 716 can include other suitable features for implementing mechanical action within the robot 102. As shown in FIG. 29, the system 700 can further include power features 722, such as a battery 724 and a charger 726. The battery 724 can be a lithium-ion battery, a sodium-ion battery, or a battery of another suitable type. The charger 726 can include a connector compatible with a power source (e.g., a wall outlet, a charging station, etc.) and leads extending between the connector and the battery 724. In at least some cases, the robot 102 is configured to operate wirelessly via the battery 724 and to recharge via the charger 726. Furthermore, the battery 724 can correspond to the battery 350. Still further, the charger 726 can correspond to the dock electrodes 206a, 206b, the robot electrodes 312a, 312b, and/or other charging-related structures of the system 100 as described above.

Finally, the system 700 can include sensor features 728 for capturing, providing, and/or analyzing information about the robot 102 itself, about the dock 104 itself, and/or about the environment in which the robot 102 and the dock 104 operate. The sensor features 728 can include a vision sensor (e.g., a camera), a light sensor (e.g., a photoresistor), a sound sensor (e.g., a microphone), a location sensor (e.g., a Global Positioning System (GPS) sensor), a two-dimensional sensor, a three-dimensional sensor, and/or a proximity sensor, among other examples. Any of these examples of the sensor features 728 can be present at the torso 106, superior to the torso 106 along the superior-inferior dimension 302, and/or elsewhere in the robot 102. Furthermore, within the torso 106 and/or at one or more other suitable locations, the robot 102 can include among the sensor features 728, an accelerometer, a gyroscope, a magnetometer, and/or a tilt sensor, among other examples. In at least some cases, two or more different types of sensors are incorporated into a sensor assembly of the robot 102. For example, an accelerometer, a gyroscope, and a magnetometer or another suitable combination of sensors can be incorporated into an inertial measurement unit (IMU) through which the robot 102 can determine parameters such as acceleration, angular velocity, and orientation. The robot 102 can include an IMU within the torso 106 and/or at one or more other suitable locations. The sensor features 728 can further include one or more sensors at the dock 104, such as an interlock sensor, a temperature sensor, etc.

At one, some, or all of the arm actuators 718, at one, some, or all of the leg actuators 720, and/or at one or more other suitable locations, the robot 102 can include among the sensor features 728, sensors that measure properties of corresponding joints. Such properties can include position, orientation (e.g., yaw, pitch, and roll), applied force (e.g., torque), elevation, mass, velocity, and acceleration, among other examples. The measurements of these properties can be direct or indirect. As an example of direct sensing, the robot 102 may sense a torque acting on a given joint via a torque sensor operably associated with the joint, such as a torque sensor that outputs torque as function of current. As another example of direct sensing, the robot 102 may sense a position of a given joint via an encoder operably associated with the joint. Any joint described herein should be construed as potentially including a torque sensor, encoder, and/or other suitable mechanism for direct sensing. As an example of indirect sensing, the robot 102 may sense a position of the dock 104 based on perception data corresponding to the dock 104 and other data corresponding to a reference. The robot 102 can include one or more sensors in a sensor system, such as a vision system, a LiDAR system, a stereoscopic camera system, a SONAR system, etc. In at least some cases, the robot 102 monitors itself and/or its environment in real-time or in near real-time. Moreover, the robot 102 may use acquired sensor data as a basis for decision-making via the computing features 702.

Features of the system 700 can be connected to one another and/or to other features of the robot 102 via suitable conductors, transmitters, receivers, circuitry, etc. While the system 700 configured as described may be used to support operation of the robot 102 and the dock 104, it should be appreciated that the robot 102 and the dock 104 may be operated using devices of various types and configurations and that such devices may have various components and levels of responsibility. For example, the robot 102 and the dock 104 may employ individual computer systems and/or controllers to manage discrete aspects of its operations, such as an individual computer system or controller to perform computer vision operations, a separate computer system or controller to perform power management, etc. In some cases, the system 700 controls physical aspects of the robot 102 and/or the dock 104 according to one or more designated rules encoded in software. For example, these rules can include minimums and/or maximums, such as a maximum degree of rotation for a joint, a maximum speed at which a link is allowed to move, a maximum acceleration rate for the legs 306a, 306b, etc. The robot 102 and the dock 104 may include any number of mechanical aspects and associated rules, which may be based on or otherwise configured in accordance with the purpose of and/or functions performed by the robot 102 and the dock 104.

Software features of the system 700 may take the form of computer-executable instructions, such as program modules executable by the computing features 702. Generally, program modules include routines, programs, objects, data structures, or the like configured to perform particular tasks based on source data, which may be encrypted. Control scripts may be implemented via a suitable language, such as C/C++ or Python®. The functionality of the program modules may be combined or distributed in various embodiments, including in cloud-based implementations. Furthermore, certain aspects of the present technology can be embodied in special purpose computers or data processors, such as in application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a LAN, a WAN, or the Internet. In a distributed computing environment, program modules and other features may be located in both local and remote memory storage and in other devices, which may be in communication via one or more wired or wireless communication channels.

Aspects of the present technology may be stored or distributed on tangible computer-readable media, which can include volatile or non-volatile storage features, such as magnetically or optically readable computer media, hard-wired or preprogrammed chips (e.g., electrically erasable programmable read-only memory semiconductor chips), nanotechnology memory, or other computer-readable storage media. Alternatively, computer-implemented instructions, data structures, screen displays, and other data under aspects of the present technology may be distributed (encrypted or otherwise) over the Internet or over other networks (including wireless networks) on a propagated signal on a propagation medium (e.g., electromagnetic wave(s), sound wave(s), etc.) over a period of time. Furthermore, such data may be provided on an analog or digital network and packet switched, circuit switched, or managed under another suitable scheme. The term computer-readable storage medium as used herein does not, however, encompass signals themselves (e.g., propagating signals) or transitory media. One of ordinary skill in the art will recognize that various features of the robot 102, the dock 104, and other devices and systems described herein may communicate via any number of wired or wireless communication techniques and that elements of such devices and systems may be distributed rather than located in a single monolithic entity. Finally, electrical and computing aspects of devices and systems in accordance with various embodiments of the present technology may operate in environments or according to processes other than the examples of environments and processes described herein.

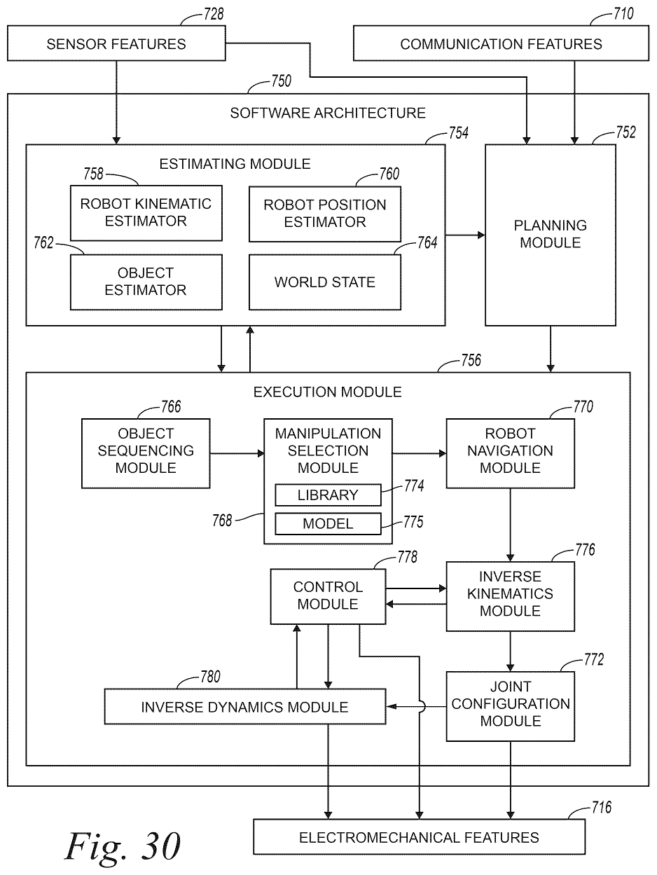

FIG. 30 is a block diagram depicting software architecture 750 and associated features of the system 700. The software architecture 750 can be within the memory 706 or otherwise operably associated with any or all of the various features of the system 700 as described above. With reference to FIGS. 1-30 together, the software architecture 750 can include a planning module 752, an estimating module 754, and an execution module 756 operably associated with one other. The planning module 752 can be configured to relay or to generate a plan corresponding to an objective for the robot 102 (e.g., unload all objects on a shelf, retrieve an object from a first location and move the object to a second location, etc.). In at least some cases, the planning module 752 receives information from the communication features 710 of the system 700 and relays or generates a plan based at least partially on the received information. For example, the planning module 752 may receive a task request from a user via the communication features 710 and relay the task request as a plan. As another example, the planning module 752 may receive a task request from a user via the communication features 710 and generate a plan related to the task request. As yet another example, the planning module 752 may generate a plan without receiving a task request from a user, such as at a predetermined time and/or in response to information about a current state of the robot 102, the dock 104, and/or the environment received via the sensor features 728 of the system 700.

The estimating module 754 can receive information from the sensor features 728 and generate estimates in real time or in near real time to inform generating and/or executing a plan. The estimating module 754 can include a robot kinematic estimator 758, a robot position estimator 760, an object estimator 762, and a world state 764. The robot kinematic estimator 758 can generate an estimate of a current kinematic state of the robot 102 (e.g., balanced, off-balance, walking, standing, etc.) and estimates of positions of individual joints of the robot 102. The robot position estimator 760 can generate a current estimate of a position of the robot 102 within an environment. This position can be a set of coordinates and can be based on perception information, GPS information, and/or other information received by or generated by the robot 102. Perception information potentially relevant to the position of the robot 102 includes, among other examples, information corresponding to distances between the robot 102 and landmarks in an environment and information corresponding to fiducial markings (e.g., AprilTags) carried by or otherwise associated with the landmarks. As mentioned above, in at least some cases, the dock 104 includes one or more fiducial markings. The information can be detected, for example, via a camera of the robot 102. Furthermore, information can move between components of the estimating module 754. For example, the world state 764 can receive information from the robot kinematic estimator 758, the robot position estimator 760, and the object estimator 762. In addition or alternatively, the object estimator 762 can receive information from the robot kinematic estimator 758 and the robot position estimator 760.

The object estimator 762 can generate a current estimate of an object (e.g., the dock 104) within an environment. In at least some cases, the estimate is a pose or other reference corresponding to a position and orientation of the object. As with the position of the robot 102 itself, the position of an object can be a set of coordinates and can be based on perception information, GPS information, and/or other information received by or generated by the robot 102. Perception information potentially relevant to the position of an object includes, among other examples, information corresponding to distances between the object and the robot 102, distances between the object and landmarks in an environment, and information corresponding to fiducial markings (e.g., AprilTags) carried by or otherwise associated with the object. This information can be detected, for example, via a camera of the robot 102. In at least some cases, the object estimator 762 uses information (e.g., sensor poses) from the robot kinematic estimator 758 and/or the robot position estimator 760 to inform generation of object estimates. This can be useful, for example, when a fiducial or other landmark in an environment is not visible. The object estimator 762 can be configured to update the world state 764 with object references and/or other information related to objects in an environment in which the robot 102 operates. Furthermore, the object estimate can include an identification of an object and properties (e.g., dimensions) associated with that identification. For example, the object estimator 762 can include an object-recognition model (e.g., Detectron2 (Facebook AI Research) with Mask R-CNN implementation) that receives perception information (e.g., an image) corresponding to an object and outputs an object identification based at least partially on the perception information. The object estimator 762 can further include a lookup table for generating object properties based at least partially on this object identification.

The execution module 756 can be configured to receive a plan from the planning module 752 and estimates from the estimating module 754. The plan can include one or more motion commands and/or motion-command precursors. The execution module 756 can include an object sequencing module 766, a manipulation selection module 768, a robot navigation module 770, and a joint configuration module 772. The planning module 752 can be configured to send a plan to the object sequencing module 766, to the manipulation selection module 768, to the robot navigation module 770, or to the joint configuration module 772 based on attributes of the plan. For example, when a plan includes explicit instructions for positions of the electromechanical features 716 of the system 700, the planning module 752 can send the plan to the execution module 756 via the joint configuration module 772. As another example, when a plan does not involve manipulating an object, the planning module 752 can send the plan to the execution module 756 via the robot navigation module 770. As yet another example, when a plan concerns only one object and the object is remote to the robot 102, the planning module 752 can send the plan to the execution module 756 via the manipulation selection module 768. As a final example, when a plan concerns multiple objects remote to the robot 102, the planning module 752 can send the plan to the execution module 756 via the object sequencing module 766.

The object sequencing module 766 can receive one or more estimates from the estimating module 754 and can generate a sequence in which multiple objects are to be manipulated. For example, when the object sequencing module 766 receives a plan to unload a shelf, the object sequencing module 766 can query the estimating module 754 for current locations of objects on the shelf. The object sequencing module 766 can then assign the objects an order, convert the order into a queue, and pass the queue to the manipulation selection module 768. The manipulation selection module 768 can include a library 774 including manipulation primitives and/or sequences of manipulation primitives that can be used to manipulate an object. The manipulation selection module 768 can select manipulation primitives and/or sequences for a given object based on contextual information, such as information about the object and/or information about the environment. In addition or alternatively, the manipulation selection module can include a model 775 that outputs manipulation estimates based on contextual information. The robot navigation module 770 can generate targets for different parts of the robot 102 further to a manipulation portion or other portions of a plan being executed. Examples of targets include positions of links of the arms 308a, 308b in the environment, positions of links of the legs 306a, 306b in the environment, the position of the dock hanger 208, etc. The robot navigation module 770 can update these targets continuously or near continuously based on information from the estimating module 754. The execution module 756 can further include an inverse kinematics module 776 that translates the targets from the robot navigation module 770 into joint configurations throughout the robot 102.

The execution module 756 can also include a control module 778 that receives joint configurations from the inverse kinematics module 776 and generates joint parameters (e.g., positions, velocities, accelerations, etc.) to be executed by the robot 102 via the electromechanical features 716 of the system 700 to achieve these joint configurations. Through continuous or near-continuous communication with the inverse kinematics module 776, the control module 778 can modify the joint parameters to at least partially compensate for deviations as the robot 102 executes the joint configurations. The inverse kinematics module 776 can send other joint configurations not subject to active control to the joint configuration module 772 directly. Similar to the control module 778, the joint configuration module 772 can generate joint parameters (e.g., positions, velocities, accelerations, etc.) to be executed by the robot 102 to achieve joint configurations received from the inverse kinematics module 776 or from the planning module 752.

Finally, the execution module 756 can include an inverse dynamics module 780 that receives joint parameters from the control module 778 and from the joint configuration module 772. The inverse dynamics module 780 can track a desired wrench of the robot 102 and its relationship with objects in the environment, such as the dock 104. In at least some cases, the inverse dynamics module 780 references a map of robot positions and wrenches to joint torques. Based at least partially on tracking these joint torques, the inverse dynamics module 780 can modify joint parameters to achieve a desired result. For example, the inverse dynamics module 780 may modify joint parameters from the control module 778 and from the joint configuration module 772 to maintain contact between the arms 308a, 308b and an object as the robot 102 carries the object. The inverse dynamics module 780 can then send modified joint parameters to the electromechanical features 716 of the system 700 for execution. For configurations that do not involve dynamic interaction with the environment, the control module 778 and the joint configuration module 772 can send joint parameters directly to the electromechanical features 716 for execution.

Suitable software components disclosed herein can be part of a distributed system or component thereof or implemented as one or more network-based services. For example, a compute cluster within a computing service may present computing or storage services or other types of services that employ any distributed computing systems described herein to clients as network-based services. In some embodiments, a network-based service may be implemented by a software or hardware system designed to support interoperable machine-to-machine interaction over a network. A network-based service may have a gateway described in a machine-processable format. Other systems may interact with the network-based service in a manner prescribed by the description of the network-based service's gateway. For example, the network-based service may define various operations that other systems may invoke. Relatedly, the network-based service may define a particular API to which other systems may be expected to conform when requesting the various operations. In the cloud provider network context, APIs may provide a gateway for customers to access cloud infrastructure by allowing customers to obtain data from and/or to cause actions within the cloud provider network, enabling the development of applications that interact with resources and services hosted in the cloud provider network. APIs can also enable different services of the cloud provider network to exchange data with one another.

In a distributed system, some or all of the software architecture 750 and other software described herein can be executed remotely from the robot 102 and the dock 104. For example, the robot 102 can be configured to collect raw sensor data via the sensor features 728 of the system 700 and to transmit some or all of this raw sensor data to a remote server in real time or near real time for processing. The robot 102 can then receive joint commands and/or other products of this processing via communication with the server. In these and other cases, computing operations can be allocated among local and remote computing systems depending on factors such as computing demand, available computing resources, time sensitivity of computing products, etc. Moreover, even the sensor features 728 can be remote from the robot 102 in certain cases. For example, a remote sensor may track its reference frame relative to a local sensor of the robot 102 and may communicate that reference frame with sensor data it collects at any given time. A server receiving the sensor data can then use the relationship between the reference frame of the local sensor and the reference frame of the remote sensor to generate output in a reference frame compatible with processes that rely on sensor data from the local sensor only. Alternatively, in a non-distributed system, all information processing and command execution can occur locally at the robot 102, the dock 104, or other local hardware depending on the implementation.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, or generating information in accordance with various embodiments of the present technology encompass, when feasible, the others of receiving, determining, and generating the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. The term “centroid” as used herein refers to a center-like data element for a given shape in three-dimensional space. There are several known approaches to calculating centroids including approaches of greater and lesser precision. No particular approach is contemplated herein. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

1. A system, comprising:
a robot; and
a dock operably associated with the robot,
wherein:
the system is transitionable between:
an undocked state in which the robot and the dock are spaced apart from one another, and
a docked state in which the robot and the dock are in contact with one another,
the robot defines an anterior-posterior dimension, a superior-inferior dimension, and a lateral dimension perpendicular to one another,
the robot includes:
a torso,
a plurality of legs connected to the torso, wherein the robot is configured to ambulate via the plurality of legs,
a robot hanger at the torso,
a robot electrode at a posterior region of the torso along the anterior-posterior dimension, and
a battery at the torso, wherein the battery is configured to charge via the robot electrode,
the dock defines a dock depth, a dock height, and a dock width parallel to the anterior-posterior dimension, the superior-inferior dimension, and the lateral dimension, respectively, when the system is in the docked state,
the dock includes:
a dock hanger configured to contact the robot hanger when the system is in the docked state, and
a dock electrode configured to contact the robot electrode when the system is in the docked state, and
the dock electrode is spaced apart from the dock hanger along the dock height.

2. The system of claim 1, wherein the robot hanger and the dock hanger are configured to urge the torso into alignment with the dock along the lateral dimension as the system transitions from the undocked state to the docked state.

3. The system of claim 1, wherein the robot hanger and the dock hanger form a post-and-socket connection when the system is in the docked state.

4. The system of claim 1, wherein:
the robot hanger and the dock hanger define a fulcrum when the system is in the docked state; and
the fulcrum redirects a gravity force acting on the torso to increase a contact force between the robot electrode and the dock electrode when the system is in the docked state.

5. The system of claim 4, wherein:
the robot electrode and the dock electrode are a first robot electrode and a first dock electrode, respectively;
the robot includes a second robot electrode at the posterior region of the torso and superiorly spaced apart from the first robot electrode along the superior-inferior dimension;
the dock includes a second dock electrode spaced apart from the first dock electrode along the dock height; and
the second robot electrode and the second dock electrode are configured to contact one another when the system is in the docked state.

6-8. (canceled)

9. The system of claim 1, wherein:
the dock includes a main body at which the dock carries the dock electrode; and
the dock hanger protrudes upward from the main body along the dock height when the system is in the docked state.

10. The system of claim 9, wherein:
the dock hanger includes a first portion and a second portion;
the second portion of the dock hanger is between the first portion of the dock hanger and the main body; and
an average extent of the first portion of the dock hanger along the dock depth decreases at increasing distance from the main body along the dock height.

11. The system of claim 10, wherein an average extent of the first portion of the dock hanger along the dock width decreases at increasing distance from the main body along the dock height.

12. (canceled)

13. The system of claim 1, wherein the robot hanger defines a socket that opens inferiorly along the superior-inferior dimension.

14. The system of claim 1, wherein an average extent of the dock hanger along the dock width is at least two times an average extent of the dock hanger along the dock depth.

15. The system of claim 1, wherein:
the robot electrode includes:
a ramp configured for transitory wiping contact with the dock electrode as the system transitions from the undocked state to the docked state, and
a pad configured for sustained contact with the dock electrode while the system is in the docked state; and
the pad is superior to the ramp in the superior-inferior dimension.

16. The system of claim 1, wherein the robot hanger extends posteriorly from the torso.

17. The system of claim 16, wherein the robot hanger is at a superiormost 25% of the torso along the superior-inferior dimension.

18. The system of claim 17, wherein the robot electrode is at an inferiormost 25% of the torso along the superior-inferior dimension.

19. The system of claim 1, wherein the robot is configured to ambulate bipedally via the plurality of legs.

20. A method comprising:
ambulating a robot retrograde toward a dock operably associated with the robot within a system;
docking the robot at the dock after ambulating the robot, wherein docking the robot includes contacting a robot hanger of the robot and a dock hanger of the dock; and
charging a battery of the robot via a changing interface between a robot electrode of the robot and a dock electrode of the dock after docking the robot,
wherein, while changing the battery:
the robot defines a superior-inferior dimension,
the dock defines a dock height parallel to the superior-inferior dimension,
the dock electrode is spaced apart from the dock hanger along the dock height, and
the robot hanger and the dock hanger define a fulcrum that redirects a gravity force acting on a torso of the robot to increase a contact force between the robot electrode and the dock electrode.

21. The method of claim 20, wherein docking the robot includes receiving the dock hanger at a socket defined by the robot hanger.

22. The method of claim 21, wherein receiving the dock hanger at the socket includes receiving the dock hanger at the socket via an inferior opening of the socket along the superior-inferior dimension.

23. The method of claim 20, wherein docking the robot includes moving legs of the robot to transfer at least most of a total weight of the robot to the dock.

24. The method of claim 20, wherein:
during the method, the robot defines an lateral dimension perpendicular to the superior-inferior dimension; and
while docking the robot, interaction between the robot hanger and the dock hanger urges the robot electrode into alignment with the dock electrode along the lateral dimension.

25-52. (canceled)
